(19) United States
(12) Patent Application Publication
(10) Pub. No.: US 2010/0104714 A1
(43) Pub. Date: Apr. 29, 2010

(54) PASTA PREPARATION SYSTEM

(75) Inventor: Jonathan Agri, Roswell, GA (US)

Correspondence Address: FSP LLC, P.O. BOX 890, VANCOUVER, WA, 98666, US

(73) Assignee: AGG Manufacturing Incorporated, Roswell, GA (US)

(21) Appl. No.: 12/257,237

(22) Filed: Oct. 23, 2008

(51) Int. Cl. A23B 4/06; A21D 6/00

(52) U.S. Cl. 426/393; 426/497

(57) ABSTRACT

A method and system for reducing the cooking time of individual pasta dishes. The pasta is pre-blanched to reduce the starch content and then frozen. The frozen pasta is cooked in a non-hooded countertop pasta cooker designed to run on 110V 30 amp service. The pasta is cooked in individual portions in less than three minutes and combined with pre-made sauces to make a complete dish.

The invention relates to preparing frozen food stuffs, particularly pasta and pasta sauces.

### BACKGROUND

Pasta is a popular dish that has become a mainstay of the American diet. An inconvenience of pasta dishes is the long preparation time. This makes it difficult to serve pasta quickly and is a drawback in making pasta more available particularly in convenience food locations.

Conventional methods of pasta cooking involve the hydration and cooking of pasta via immersion in boiling water. Fresh pastas take 4 to 6 minutes to cook and have a short shelf life. Frozen fresh pastas can take 5 to 8 minutes to cook. Cooking times for dried pastas can vary from 10 to 15 minutes. All of these cooking times take far too long for a convenience food setting. In order to decrease the amount of time it takes to cook pasta, restaurants use pressure cookers or super heated water necessitating cumbersome equipment not suited to the space constraints of many convenience food locations.

There is therefore a need in the art for quickly preparing individual pasta dishes using compact equipment.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a flow chart of an embodiment of a method for preparing frozen pasta.

FIG. 2 is an illustration of an embodiment of an exemplary pasta cooker

FIG. 3 is a flow chart of an embodiment of a method of cooking frozen pasta.

FIG. 4 is an illustration of an exemplary warmer.

FIG. 5 is a flow chart of an embodiment of a method of reheating pasta sauce.

FIG. 6 is an illustration of an embodiment of a combination warmer and steam table.

FIG. 7 is a flow chart of an embodiment of a method of preparing pasta with sauce.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

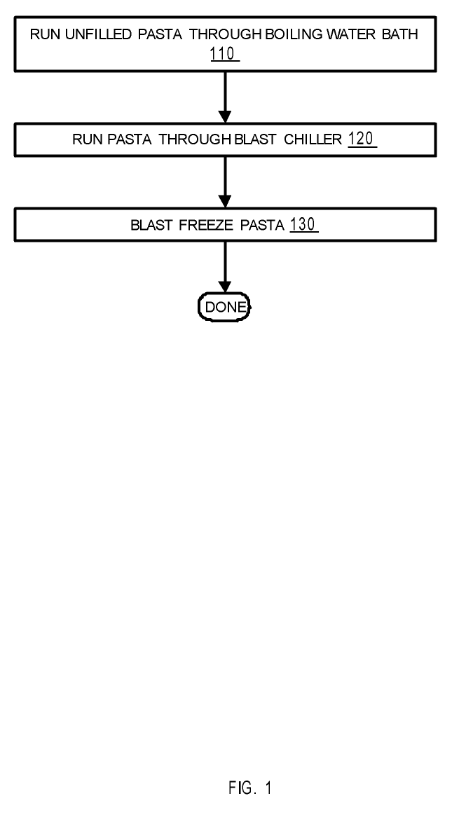

Devices and techniques are described herein to improve the cooking time of frozen fresh pasta by pre-blanching the pasta to reduce starch. Such a process may be used on any types of filled or unfilled pasta including, but not limited to, gemelli, linguini, fettuccini, cheese tortellini, cheese ravioli, meat ravioli, rigatoni, agnilotti, spinach and egg tortelloni as well as any other type of pasta. As shown in FIG. 1, the pasta runs through a boiling water bath 110. This process releases some of the starch in the pasta allowing it to cook more quickly when reheated. The amount of time in the boiling water bath may vary depending on the thickness or type of pasta. In some embodiments, the pasta may be run through a boiling water bath for 1, 2, 3, 4 or 5 minutes. The boiling process may release about 20-50% of the starch, preferably about 45% of the starch.

The pasta is then run through a blast chiller as shown in step 120. The blast chiller may be set from about −10 to about 0 degrees Fahrenheit, in some embodiments, the blast chiller will be about −5 degrees Fahrenheit. The pasta will be chilled until cold, preferably from about 3 to about 10 minutes, in some embodiments the pasta will run through the blast chiller for about five minutes.

The pasta is then blast frozen 130. Blast freezing may take place at a range of temperatures from about −30 to about −15 degrees Fahrenheit. In some embodiments, the blast freezing may take place at about −20 degrees Fahrenheit. The pasta is chilled for about 10 to about 30 minutes until it is completely frozen. In some embodiments it is chilled for about 20 minutes. The pasta is then packaged and returned to a freezer for shipping.

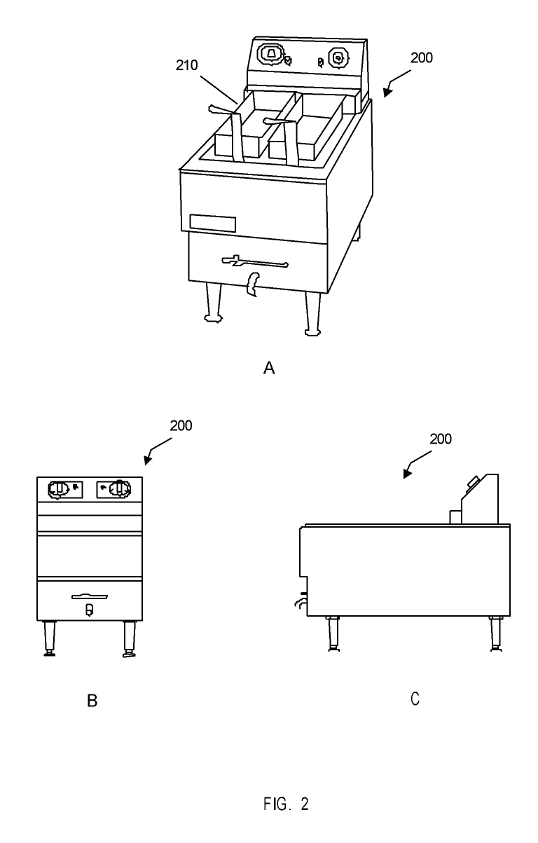

Once the pasta is delivered to its serving location, such as, for example, a convenience store, each package may be reheated individually. In some embodiments, the pasta may be packaged in individual servings. In other embodiments, the pasta may be easily divisible into individual servings. When a pasta order is placed, the frozen pasta may be placed into a countertop pasta cooker. Any type of pasta cooker that runs on 110V 30 amp service may be used. A typical pasta cooker 200 is shown in FIG. 2. The preferred dimensions of the pasta cooker are such that it can easily fit on a countertop or other small surface. The pasta cooker 200 contains multiple receptacles 210 which can be used to cook individual portions of pasta. FIG. 2A shows two receptacles for simplicity, however, any number of receptacles may be placed in a pasta cooker depending on the needs of the facility selling the pasta. Each receptacle 210 is designed to hold single servings of pasta. Such servings may range from about 5 to 10 ounces of pasta. In some embodiments, the servings may be about 6 to about 7 ounces of pasta. The receptacles may be of any size desired, in some embodiments the receptacles are designed to hold more than the serving size to allow for the expansion of the pasta. In other embodiments, the receptacles hold one ounce more than the serving size. In further embodiments, the receptacles hold 7 ounces.

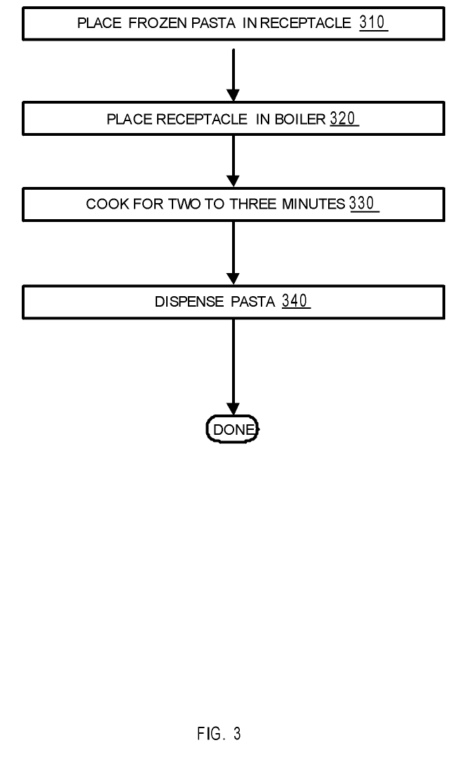

As shown in FIG. 3, the frozen pre-blanched pasta is placed in a receptacle 310. The receptacle is placed in a boiler 320 and the pasta is cooked for 2-3 minutes 330. In some embodiments, the pasta may be cooked for about 2.5 minutes. In other embodiments the pasta may be cooked for less than about three minutes. Filled and unfilled pastas may have different cooking times. The pasta is then dispensed 340 and is ready to be mixed with any type of sauce desired. Sauces may be any type of sauce generally served with pasta. For example, sauces such as Nona's Spaghetti Gravy, Nona's Meat sauce, Marinara Sauce, Sausage Vodka Cream, Carbonara Sauce, Alfredo Sauce, or Shitake Mushroom Marinara may be used with the pasta. The pasta sauces are non-breaking when maintained at a temperature above 145 degrees Fahrenheit. Such sauces may be prepared by any means possible. In some embodiments, the ingredients of the sauces are put in production kettles and heated to a particular temperature, for example from about 150 to 200 degrees Fahrenheit. In some embodiments, the sauce is heated to 180 degrees Fahrenheit. The sauces are then piped in to bags in the desired weights. Any appropriate weight may be used, for example sauces may be pumped into bags from about 1 to about 10 pounds. In some embodiments they are piped into bags of about 1 pound. In other embodiments they are piped into bags of about 5 pounds. In further embodiments they are piped into bags of 2 pounds. The bags are then chilled by any means conventionally used in the sauce processing industry. In some embodiments, the sauces are transferred to a cold water bath. The cold water bath may be at any temperature generally used to cool hot foods. For example the cold water bath maybe between 10 and 30 degrees Fahrenheit. In some embodiments, the cold water bath may be 20 degrees Fahrenheit. The sauces may be chilled for the appropriate length of time to reach a safe temperature. In some embodiments the sauces are chilled from about 15 to 30 minutes. In other embodiments, the sauces are chilled for about 20 minutes. Packaged sauces are then stored in a blast freezer to finish freezing. The blast freezer may be set at any temperature typically used for blast freezing. In some embodiments, the blast freezer is set to about −50 to about −20 degrees Fahrenheit. In one embodiment, the blast freezer is set to about −30 degrees Fahrenheit.

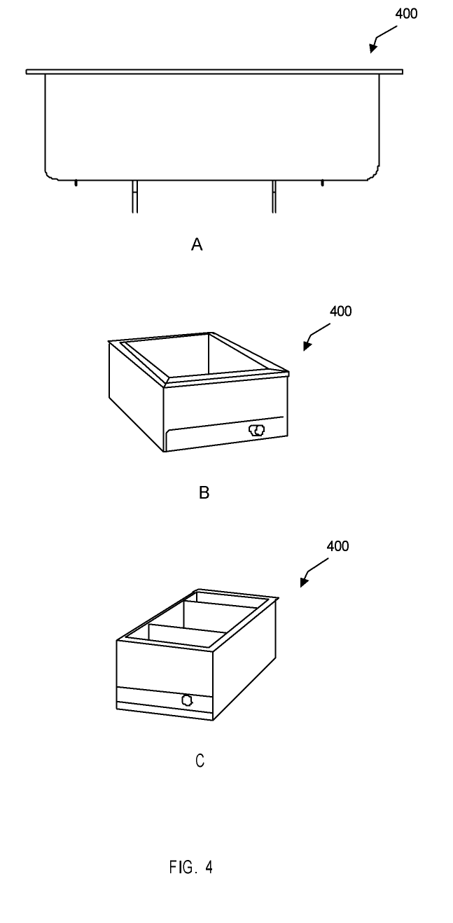

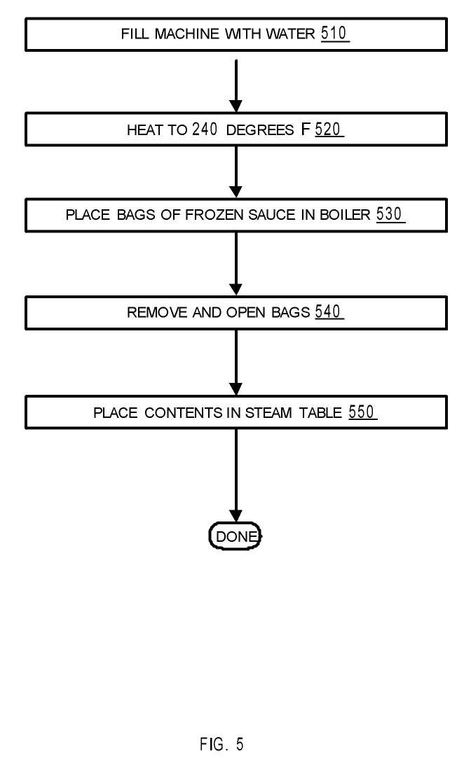

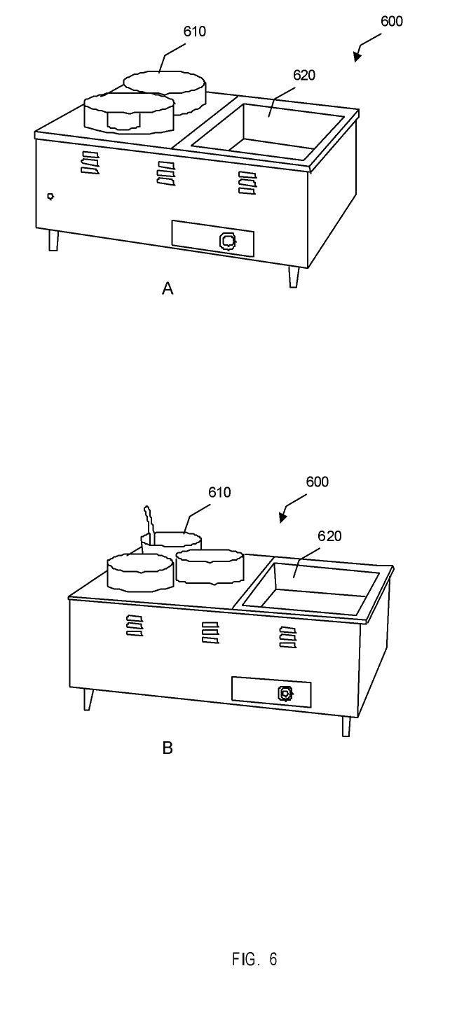

Frozen sauces may be reheated at the sales location by any means applicable. For example, they may be reheated using a warmer as shown in FIG. 4. Bags of sauce may be placed in a warmer and heated to the desired temperature. In some embodiments, the warmer 400 may be one container as shown in FIG. 4B. In other embodiments, the warmer 400 may be divided as shown in FIG. 4C. For ease of description the warmer 400 is described having three compartments. However, the warmer may be divided into as many or as few compartments as desired. The bags of sauce are boiled from 10-20 minutes. In some embodiments, the bags are boiled for 15 minutes. Preparation of the warmer for the sauces may take place at any time convenient to serving the pasta. For example, as shown in FIG. 5, the warmer may be filled with water 510. The water may be heated to any temperature appropriate for food safety as long as it does not exceed 300 degrees Fahrenheit. By keeping the temperature under 300 degrees Fahrenheit, it is possible to use the warmer without hood ventilation. As shown in FIG. 5, in some embodiments the water is then heated to 240 degrees Fahrenheit 520. Bags of frozen sauce are then placed in the boiler 530 and heated until it reaches the appropriate temperature. The bags are then removed 540, opened and placed in a steam table 550. In some embodiments, the warmer 620 and the steam table may be combined as shown in FIG. 6. In one embodiment, the pasta may be prepared in the combined warmer and steam table. Multiple sauces may be placed in different canisters 610. For the sake of simplicity, two and three canisters of sauce are shown, but any number of canisters may be used for dispensing the sauce. In some embodiments, additional ingredients may be added to the sauces or packaged to take home. Such additional ingredients may include meatballs, sausages, or any other meat product commonly found in pasta sauces.

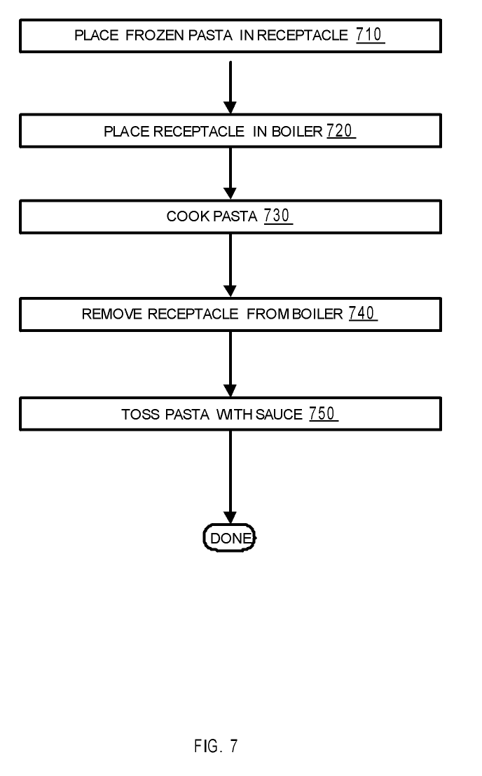

As shown in FIG. 7 a single serving of frozen pasta 710 is placed in a receptacle 210 of the pasta cooker 200. The receptacle is placed in the boiler 720. The pasta is cooked for the appropriate length of time 730. In some embodiments a timer may be used to measure the length of time for cooking the pasta. In other embodiments, the timer may be set for filled or unfilled pasta. The pasta is then removed from the boiler 740 and tossed with the appropriate sauce 750. In some embodiments, additional sauce may be placed on top of the pasta. In other embodiments, additional condiments such as cheese, hot sauce or pepper flakes may be placed on top of the pasta.

The following examples illustrate certain aspects of the invention, but are not intended to limit in any manner the scope of the invention.

### EXAMPLE 1

### Pre-Blanching of Pasta

Pasta was prepared and extruded into the pasta shape desired. The pasta was then run through a boiling water bath for two minutes to release 45% of the starch content. The boiled pasta was then sent through a blast chiller at −5 degrees Fahrenheit for 5 minutes. The pasta was then blast frozen at −20 degrees Fahrenheit for 20 minutes. The frozen pasta was then weighed and packaged in predetermined amounts.

### EXAMPLE 2

### Production of Sauces

Sauces are prepared in conventional kettles, using old fashioned cooking techniques, and are cooked in such a way that they are not the usual preparation of premade sauces which are made in superheated pipes that get to 180 degrees and are then bagged or bottled. Rather, in the current process sauces are prepared over a one to three hour period depending on the sauce, and are then bagged, and quick cooled to prevent any crystals from forming in the sauce bag. Done this way, the sauces don't need any unnatural stabilizers or preservatives.

Bags of sauce are then filled to either 1 pound or 5 pound weights and sealed. The bags were then transferred to a 20 degree Fahrenheit cold water bath for twenty minutes. Once the bags were chilled to 20 degrees Fahrenheit, they were packaged and stored in a −30 degree Fahrenheit blast freezer for 48 hours.

### EXAMPLE 3

### Reheating of Sauce

A Nemco model #6055A-CW sauce warmer (Nemco, Hicksville, Ohio) was filled with water and heated to 240 degrees Fahrenheit. Frozen bags of sauce were placed in the boiler and boiled for fifteen minutes. The bags were then removed, opened and placed in a steam table.

### EXAMPLE 4

### Reheating of Pasta

A Nemco model #6750-240W (Nemco, Hicksville, Ohio) pasta cooker was converted to an 110V 30 amp service. A receptacle of the pasta cooker was filled with six ounces of pasta. The receptacle was placed in a boiler. A timer was activated for unfilled or filled pasta. When the timer went off, the basket was removed allowing the water to drain. The pasta was then placed in a pasta tossing bowl and tossed with four ounces of the desired sauce. The tossed pasta was then placed in a serving bowl and topped with two ounces of sauce and sprinkled with cheese.

What is claimed is:

1. A process of pre-blanching non-filled pasta to remove about 45% of the starch content comprising:
placing the non-filled pasta in boiling water;
blast chilling the pasta; and
blast freezing the pasta.

2. The process of claim 1, wherein the pasta is packaged in individual portions.

3. The process of claim 2 wherein an individual portion is 6 ounces of pasta.

4. The process of claim 1, wherein the pasta is placed in boiling water for 2 minutes.

5. The process of claim 1, wherein the pasta is blast frozen at −20 degrees Fahrenheit.

6. A process of re-heating a frozen pre-blanched pasta comprising:
placing the pre-blanched pasta in a receptacle of a non-hooded pasta countertop pasta cooker;
cooking the pre-blanched pasta for less than about three minutes; and
dispensing the pasta.

7. The process of claim 6 wherein the pre-blanched pasta is re-heated in individual portions.

8. The process of claim 6 wherein the non-hooded countertop pasta cooker is adapted to operate on 110V 30 amp electrical service.

9. The process of claim 6 wherein the non-hooded pasta countertop pasta cooker has multiple single portion receptacles.

10. The process of claim 9 wherein the receptacles are 7 ounce portion receptacles.

11. A process of re-heating a frozen pre-blanched pasta and a frozen pre-made sauce comprising:
placing the pre-blanched pasta in a receptacle of a non-hooded pasta countertop pasta cooker;
cooking the pre-blanched pasta for about 2.5 minutes;
heating the sauce in a non-hooded countertop food warmer; and
combining the cooked pasta and the sauce.

12. The process of claim 11 wherein the sauce is a non-breaking sauce.

13. The process of claim 11 wherein the pre-blanched pasta is an unfilled pasta.

14. The process of claim 11 wherein the combined cooked pasta and sauce is topped with additional sauce.

15. The process of claim 14 wherein the combined cooked pasta and sauce is topped with cheese.

16. The process of claim 11 wherein the non-hooded pasta countertop cooker is adapted to operate on 110V 30 amp electrical service.

17. The process of claim 11 wherein the sauce is heated in a bag.

18. The process of claim 11 wherein the sauce is heated for fifteen minutes.
